(19) United States
(12) Patent Application Publication
(10) Pub. No.: US 2022/0406125 A1
(43) Pub. Date: Dec. 22, 2022

(54) GAME STATE DETECTION AND CONFIGURATION UPDATING METHOD AND APPARATUS, DEVICE AND STORAGE MEDIUM

(71) Applicant: SENSETIME INTERNATIONAL PTE. LTD., Singapore (SG)

(72) Inventors: Jiacheng WU, Singapore (SG); Shuai ZHANG, Singapore (SG); Gan XIAO, Singapore (SG); Xin GAN, Singapore (SG); Wenxuan WU, Singapore (SG)

(21) Appl. No.: 17/363,309

(22) Filed: Jun. 30, 2021

Related U.S. Application Data
(63) Continuation of application No. PCT/IB2021/055652, filed on Jun. 25, 2021.

(30) Foreign Application Priority Data
Jun. 16, 2021 (SG) 10202106467P

(51) Int. Cl. G07F 17/32

(52) U.S. Cl. CPC G07F 17/3223; G07F 17/3239; G07F 17/3206

(57) ABSTRACT

The embodiments of the disclosure provide a game state detection and configuration updating method and apparatus, a device and a storage medium. The method includes that: description information of multiple configuration files of a first game table is acquired from a cloud; first description information is determined from the description information of the multiple configuration files, the version of a first configuration file described by the first description information being higher than that of a first local configuration file of the corresponding first game table; the first configuration file is acquired from the cloud to update the first local configuration file; and a game state of the first game table is detected according to the updated first local configuration file, as well as a first image collected for the first game table. The disclosure improves the accuracy of game state detection and the efficiency of configuration updating.

### CROSS-REFERENCE TO RELATED APPLICATION

This is continuation application of international application PCT/IB2021/055652, filed on 25 Jun. 2021, which claims priority to Singapore patent application No. 10202106467P, filed with IPOS on 16 Jun. 2021. The contents of international application PCT/IB2021/055652 and Singapore patent application No. 10202106467P are incorporated herein by reference in their entireties.

### TECHNICAL FIELD

The disclosure relates to computer vision technologies, and more particularly, to a game state detection and configuration updating method and apparatus, a device and a storage medium.

### BACKGROUND

In an intelligent table game scenario, data analysis for an intelligent game table may be carried out by an edge terminal. Here, the edge terminal refers to a data processing device deployed in the vicinity of the game table. The edge terminal may acquire a configuration file of the intelligent game table from a cloud to update a local configuration file of the intelligent game table, so as to perform the data analysis according to the configuration file. However, if the configuration file on the cloud is not updated, or, the configuration file acquired by the edge terminal from the cloud is updated only in part, the fact that the edge terminal acquires the configuration file from the cloud to update the configuration file of the edge terminal will increase the communication cost, and affect the efficiency of configuration updating of the edge terminal, thereby affecting the accuracy of game state detection.

### SUMMARY

Embodiments of the disclosure provide a game state detection and configuration updating method and apparatus, a device and a storage medium, which improves the efficiency of configuration updating and the accuracy of game state detection.

The technical solutions of the disclosure are implemented as follows.

The embodiments of the disclosure provide a game state detection method, which may include the following operations.

Description information of multiple configuration files of a first game table is acquired from a cloud; first description information is determined from the description information of the multiple configuration files, the version of a first configuration file described by the first description information being higher than the version of a corresponding first local configuration file of the first game table; the first configuration file is acquired from the cloud; the first local configuration file is updated with the first configuration file to obtain an updated first local configuration file; and a game state of the first game table is detected according to the updated first local configuration file, as well as a first image collected for the first game table.

In this way, a first edge terminal device may acquire the updated first configuration file from the cloud to update the first local configuration file, and further performs game state detection according to the updated first local configuration file. Therefore, the efficiency of configuration updating is improved, and the accuracy of game state detection is improved.

In some embodiments, the operation that the first description information is determined from the description information of the multiple configuration files includes that: the description information of each of the multiple configuration files is compared with description information of respective one of multiple first local configuration files to determine the first description information, the multiple first local configuration files including configuration information of multiple components of the first game table.

In some embodiments, the operation that the description information of the multiple configuration files of the first game table is acquired from the cloud includes that: a first configuration update request is sent to the cloud in a case where a configuration update condition is satisfied, the first configuration update request being configured to request the description information of the multiple configuration files; and the description information of the multiple configuration files that is fed back by the cloud in response to the first configuration update request is received.

In some embodiments, the operation that the first configuration file described by the first description information among the multiple configuration files is acquired from the cloud includes that: a first file request is sent to the cloud, the first file request carrying the first description information; and the first configuration file fed back by the cloud in response to the first file request is received.

In some embodiments, the method further includes that: description information of multiple second local configuration files from each second edge terminal is received; the description information of each of the multiple first local configuration files is compared with the description information of respective one of the multiple second local configuration files of each second edge terminal to determine second description information, the version of a configuration file described by the second description information being higher than the version of a corresponding first local configuration file; a second configuration file described by the second description information is acquired from multiple second local configuration files of an edge terminal corresponding to the second description information; and the first local configuration file is updated with the second configuration file to obtain the updated first local configuration file.

In some embodiments, the operation that the first configuration file fed back by the cloud in response to the first file request is received includes that: the multiple first configuration files fed back by the cloud in response to the first file request through multiple threads are received.

In some embodiments, the method further includes that: restoration notification information from the cloud is received, the restoration notification information being configured to characterize a normal operation of the cloud; the description information of the multiple configuration files is acquired from the cloud in response to the restoration notification information; and the updated first local configuration file is acquired based on the description information of the multiple configuration files.

In some embodiments, the multiple configuration files include: a configuration file of a collection component corresponding to a collection device and a configuration file of a table component of a table game.

In some embodiments, the operation that the game state of the first game table is detected according to the updated first local configuration file, as well as the first image collected for the first game table includes at least one of: a game process of the first game table is detected according to the updated first local configuration file, as well as the first image collected for the first game table; an operation of a game participant of the first game table is detected according to the updated first local configuration file, as well as the first image collected for the first game table; or a game result of the first game table is detected according to the updated first local configuration file, as well as the first image collected for the first game table.

In some embodiments, the description information includes a version number of a file.

The embodiments of the disclosure provide a configuration updating method, which may include the following operations.

A configuration update request from a first edge terminal is received; in response to the configuration update request, description information of each configuration file among multiple configuration files of a first game table corresponding to the first edge terminal is sent to the first edge terminal; a first file request from the first edge terminal is received, the first file request carrying first description information determined from multiple pieces of the description information, and the version of a first configuration file described by the first description information being higher than the version of a first local configuration file of the first game table; and the first configuration file is sent to the first edge terminal in response to the first file request.

In some embodiments, the operation that in response to the configuration update request, the description information of each configuration file among the multiple configuration files of the first game table corresponding to the first edge terminal is sent to the first edge terminal includes that: in response to the configuration update request, the multiple configuration files of the first game table corresponding to the first edge terminal are determined from multiple cloud configuration files; and description information of each configuration file among the determined multiple configuration files is sent to the first edge terminal.

The embodiments of the disclosure provide a game state detection apparatus, which includes: an acquisition module, a determination module, an updating module and a detection module.

The acquisition module is configured to acquire description information of multiple configuration files of a game table from a cloud.

The determination module is configured to determine first description information from the description information of the multiple configuration files, the version of a first configuration file described by the first description information being higher than the version of a corresponding first local configuration file of a first game table.

The acquisition module is further configured to acquire the first configuration file from the cloud.

The updating module is configured to update the first local configuration file with the first configuration file to obtain an updated first local configuration file.

The detection module is configured to detect a game state of the first game table according to the updated first local configuration file, as well as a first image collected for the first game table.

In some embodiments, the determination module is further configured to compare the description information of each of the multiple configuration files with description information of respective one of multiple first local configuration files to determine the first description information, the multiple first local configuration files including configuration information of multiple components of the first game table.

In some embodiments, the game state detection apparatus further includes a first reception module and a first sending module; the first sending module is configured to send a first configuration update request to the cloud in a case where a configuration update condition is satisfied, the first configuration update request being configured to request the description information of the multiple configuration files; the first reception module is configured to receive the description information of the multiple configuration files that is fed back by the cloud in response to the first configuration update request.

In some embodiments, the first sending module is further configured to send a first file request to the cloud, the first file request carrying the first description information; and the first reception module is further configured to receive the first configuration file fed back by the cloud in response to the first file request.

In some embodiments, the first sending module is further configured to send a second configuration update request to at least one second edge terminal in a case where a response of the cloud to the first configuration update request is not received within a preset time period, the second configuration update request being configured to request description information of multiple second local configuration files of each second edge terminal in the at least one second edge terminal; the first reception module is further configured to receive the description information of the multiple second local configuration files from each second edge terminal; the first determination module is further configured to compare the description information of each of the multiple first local configuration files with the description information of respective one of the multiple second local configuration files of each second edge terminal to determine second description information, the version of a configuration file described by the second description information being higher than the version of a corresponding first local configuration file; the first updating module is further configured to update the first local configuration file with the second configuration file to obtain the updated first local configuration file.

In some embodiments, the first reception module is further configured to receive the multiple first configuration files fed back by the cloud in response to the first file request through multiple threads.

In some embodiments, the first reception module is further configured to receive restoration notification information from the cloud, the restoration notification information being configured to characterize a normal operation of the cloud; the acquisition module is further configured to acquire the description information of the multiple configuration files from the cloud in response to the restoration notification information, and acquire the updated first local configuration file based on the description information of the multiple configuration files.

In some embodiments, the multiple configuration files include: a configuration file of a collection component corresponding to a collection device, and a configuration file of a table component of a table game.

In some embodiments, the detection module is further configured to implement at least one of the followings: detecting a game process of the first game table according to the updated first local configuration file, as well as the first image collected for the first game table; detecting an operation of a game participant of the first game table according to the updated first local configuration file, as well as the first image collected for the first game table; or detecting a game result of the first game table according to the updated first local configuration file, as well as the first image collected for the first game table.

In some embodiments, the description information may include a version number of a file.

The embodiments of the disclosure provide a configuration update apparatus, which includes: a second reception module, and a second sending module.

The second reception module is configured to receive a configuration update request from a first edge terminal.

The second sending module is configured to send, in response to the configuration update request, description information of each configuration file among multiple configuration files of a first game table corresponding to the first edge terminal to the first edge terminal.

The second reception module is further configured to receive a first file request from the first edge terminal; the first file request carrying first description information determined from multiple pieces of the description information, and the version of a first configuration file described by the first description information being higher than that of a first local configuration file of the first game table.

The second sending module is further configured to send the first configuration file to the first edge terminal in response to the first file request.

In some embodiments, the second sending module is further configured to: determine, in response to the configuration update request, the multiple configuration files of the first game table corresponding to the first edge terminal from multiple cloud configuration files; and send the description information of each configuration file among the determined multiple configuration files to the first edge terminal.

The embodiments of the disclosure provide an electronic device, which may include: a memory and a processor.

The memory is configured to store a computer program.

The processor is configured to execute the computer program stored in the memory, to implement the game state detection method or the configuration updating method described above.

The embodiments of the disclosure provide a computer storage medium, which stores a computer program, configured to implement, when executed by a processor, the game state detection method or the configuration updating method described above.

### BRIEF DESCRIPTION OF THE DRAWINGS

FIG. 1 is a structural schematic diagram of an optional game state detection system provided by an embodiment of the disclosure.

FIG. 2 is a flowchart of an optional game state detection method provided by an embodiment of the disclosure.

FIG. 3 is a flowchart of an optional game state detection method provided by an embodiment of the disclosure.

FIG. 4 is a flowchart of an optional game state detection method provided by an embodiment of the disclosure.

FIG. 5 is a flowchart of an optional game state detection method provided by an embodiment of the disclosure.

FIG. 6 is a flowchart of an optional game state detection method provided by an embodiment of the disclosure.

FIG. 7 is a flowchart of an optional configuration updating method provided by an embodiment of the disclosure.

FIG. 8 is a flowchart of an optional game state detection method provided by an embodiment of the disclosure.

FIG. 9 is a flowchart of an optional game state detection method provided by an embodiment of the disclosure.

FIG. 10 is a structural schematic diagram of an optional game state detection apparatus provided by an embodiment of the disclosure.

FIG. 11 is a structural schematic diagram of an optional configuration update apparatus provided by an embodiment of the disclosure.

FIG. 12 is a structural schematic diagram of an optional electronic device provided by an embodiment of the disclosure.

### DETAILED DESCRIPTION

In order to make the objectives, technical solutions and advantages of the disclosure further clear, the disclosure will be described below in further detail in combination with the accompanying drawings. The described embodiments should not be considered as limits to the disclosure. All other embodiments obtained on the premise of no creative work of those of ordinary skill in the art should fall within the scope of protection of the disclosure.

In the following description, “some embodiments” are involved, which describes subsets of all possible embodiments. However, it may be understood that the “some embodiments” may be the same subsets or different subsets of the all possible embodiments, and may be combined with each other without conflicts.

In the following description, the terms “first/second/third” related are merely for distinguishing similar objects rather than a special order of the objects. It is to be understood that the “first/second/third” may exchange a special sequence or chronological sequence in an allowed condition, such that the embodiments of the disclosure described herein can be implemented in a sequence other than that illustrated or described herein.

Unless otherwise defined, all technical and scientific terms used herein have a same meaning generally understood by those skilled in the art to which the disclosure belongs. The terms used herein are merely to describe the embodiments of the disclosure, rather than to limit the disclosure.

The embodiments of the disclosure provide a game state detection method and apparatus, an electronic device and a storage medium, which can improve the accuracy of game state detection. The following descriptions are made to exemplary applications of the electronic device provided by the embodiments of the disclosure. The electronic device provided by the embodiments of the disclosure may be implemented as an intelligent game device such as the intelligent game table for the chess and card games, and may also be implemented as various types of user terminals such as notebook, tablet, table computer, set-top box, and mobile device (e.g., mobile phone, portable music player, Personal Data Assistant (PDA), special messaging device, portable game device).

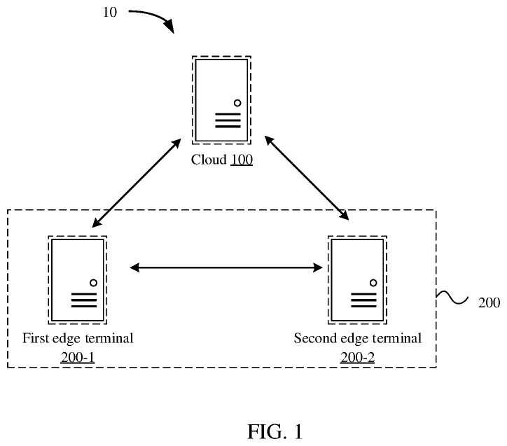

Reference is made to FIG. 1. FIG. 1 is an optional architecture schematic diagram of a game state detection system 10 provided by an embodiment of the disclosure. The game state detection system 100 includes a cloud 100 and multiple edge terminals 200. The cloud 100 communicates with the multiple edge terminals 200 (exemplarily shown as the first edge terminal 200-1 and the second edge terminal 200-2); and the first edge terminal 200-1 and the second edge terminal 200-2 communicate to each other.

In the embodiment of the disclosure, the cloud 100 stores configuration files of the multiple edge terminals 200. The configuration file of each edge terminal includes configuration information of a corresponding game table, such as the type and the game rule of the game table. Each edge terminal acquires its own configuration file from the cloud 100, and after its own configuration file is updated on the cloud, acquires the updated configuration file from the cloud to update its own configuration.

In the embodiment of the disclosure, the first edge terminal 200-1 is configured to: acquire description information of multiple configuration files of a first game table from the cloud 100; determine first description information from the description information of the multiple configuration files, the version of a first configuration file described by the first description information being higher than that of a corresponding first local configuration file of the first game table; acquire the first configuration file from the cloud 100; update the first local configuration file with the first configuration file to obtain an updated first local configuration file; and detect a game state of the first game table according to the updated first local configuration file, as well as a first image collected for the first game table. The cloud 100 is configured to: receive a configuration update request from the first edge terminal 200-1; send, in response to the configuration update request, description information of each configuration file among multiple configuration files of a first game table corresponding to the first edge terminal 200-1 to the first edge terminal; receive a first file request from the first edge terminal 200-1, the first file request carrying first description information determined from multiple pieces of the description information, and the version of a first configuration file described by the first description information being higher than that of a first local configuration file of the first game table; and send the first configuration file to the first edge terminal 200-1 in response to the first file request.

Exemplarily, in a table game scenario, the first edge terminal 200-1 corresponds to a first game table; the first edge terminal 200-1 stores 3 first local configuration files of the first game table: A.1, B.1 and C.1, where the configuration file A includes configuration information of a camera component on the first game table, the configuration file B includes configuration information of a token region, and the configuration file C includes configuration information of a dealing region; in files stored on the cloud 100, multiple configuration files corresponding to the above 3 first local configuration files are sequentially A.2, B.1 and C.1, where the version of the A.2 is higher than that of the A.1. The first edge terminal 200-1 may acquire the A.2 from the cloud 100 to update the first local configuration file A.1 to obtain updated first local configuration files A.2, B.1 and C.1. Therefore, the first edge terminal 200-1 may detect whether a region for placing the token on the first game table is correct, and/or whether a dealing sequence on the first game table is correct, according to the updated first local configuration files A.2, B.1 and C.1, as well as a scenario image of the first game table.

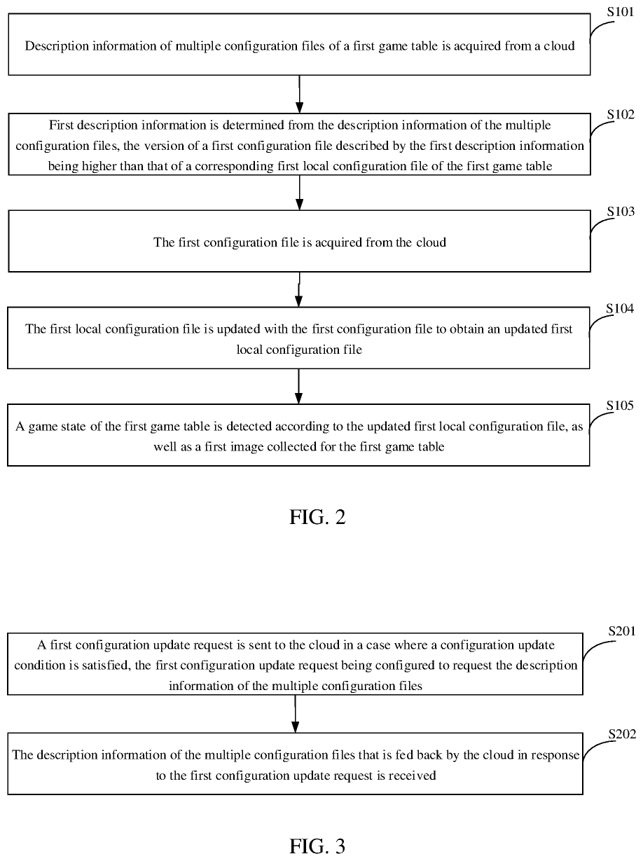

Reference is made to FIG. 2. FIG. 2 is an optional flowchart schematic diagram of a game state detection method provided by an embodiment of the disclosure. The game state detection method is applied to a first edge terminal, and is described in combination with steps shown in FIG. 2.

In S101, description information of multiple configuration files of a first game table is acquired from a cloud.

In the embodiment of the disclosure, the cloud includes multiple cloud configuration files, and the multiple cloud configuration files are configured to configure at least one game table corresponding to at least one edge terminal. In order to facilitate the cloud to manage configuration information of multiple edge terminals, in a case where any local configuration file needs to be updated, a cloud configuration file corresponding to the local configuration file is updated first at the cloud; and then, the edge terminal updates the local configuration file through the cloud configuration file on the cloud.

In the embodiment of the disclosure, the first edge terminal stores multiple first local configuration files, and configures the first game table through the multiple first local configuration files. Therefore, the first edge terminal may acquire multiple configuration files among the multiple cloud configuration files from the cloud, the multiple configuration files corresponding to the multiple first local configuration files.

Exemplarily, an edge terminal 1 and an edge terminal 2 are connected to the cloud. The first local configuration file stored by the edge terminal 1 includes: A, B and C. The second local configuration file stored by the edge terminal 2 includes A, B and D. The configuration file stored by the cloud includes: configuration files A, B, C and D. The description information of the multiple configuration files that is acquired by the first edge terminal from the cloud is description information of the configuration files A, B and C.

In some embodiments of the disclosure, the first edge terminal may send a configuration update request to the cloud, and acquire the description information of the multiple configuration files from the cloud through the configuration update request; or, the cloud directly sends, after the cloud configuration file is updated, the description information of the multiple configuration files to the first edge terminal, which may be set as required, and is not limited by the disclosure.

In some embodiments of the disclosure, the description information may include a file identifier and/or a file version. The file version is increased once whenever the configuration file in the cloud is updated. In some embodiments, the file version may be characterized by a version number.

Exemplarily, for the description information C.1 of the file C, C is the file identifier, and 1 is the version number of the file. If the file C is updated once, the description information changes from the C.1 to the C.2, and the version number is increased by 1; and if the file C is updated once again, the description information changes from the C.2 to the C.3, and the version number is continuously increased by 1, and so on.

In some embodiments of the disclosure, the description information may further include at least one of the followings: an edge terminal identifier of an edge terminal to which the file belongs and a configuration information identifier included in the file, which is not limited thereto by the embodiment of the disclosure.

In S102, first description information is determined from the description information of the multiple configuration files, the version of a first configuration file described by the first description information being higher than that of a corresponding first local configuration file of the first game table.

In the embodiment of the disclosure, the first edge terminal may find the first description information from the description information of the multiple configuration files upon the reception of the description information of the multiple configuration files, the file version in the first description information being higher than that of the corresponding first local configuration file. The first description information may be one or more of the description information of the multiple configuration files.

Exemplarily, the description information of the first local configuration file includes: A.1, B.1 and C.1, and the description information of the multiple configuration files that is received by the first edge terminal includes: A.2, B.2 and C.1, the first description information is thus A.2 and B.2, the version of A.2 being higher than that of A.1, and the version of B.2 being higher than that of B.1. That is, the configuration files A and B have been updated in the cloud, and the A and the B in the first local files of the first game table need to be updated.

In S103, the first configuration file is acquired from the cloud.

In the embodiment of the disclosure, the first edge terminal may acquire the first configuration file from the cloud according to the first description information upon the determination of the first description information. The description information of the first configuration file is the first description information.

In the embodiment of the disclosure, the first description information may include a first file identifier and/or a first file version. The first edge terminal may acquire a configuration file having the first file identifier from the multiple configuration files of the cloud to take as the first configuration file, and may also acquire a configuration file having description information identical to the first description information to take as the first configuration file, which is not limited thereto by the embodiment of the disclosure.

In S104, the first local configuration file is updated with the first configuration file to obtain an updated first local configuration file.

In the embodiment of the disclosure, after acquiring the first configuration file, the first edge terminal may update the first local configuration file with the first configuration file to obtain the updated first local configuration file.

In some embodiments, the first edge terminal may replace the corresponding first local configuration file with the first configuration file to obtain the updated first local configuration file.

Exemplarily, the first local configuration file includes: configuration files having identifiers or version numbers of A.1, B.1 and C.1. After acquiring first configuration files “A.2” and “B.2”, the first edge terminal may replace “A.1” with “A.2”, and replace “B.1” with “B.2”, to obtain the update first local configuration file: configuration files having identifiers of A.2, B.2 and C.1.

In S105, a game state of the first game table is detected according to the updated first local configuration file, as well as a first image collected for the first game table.

In the embodiment of the disclosure, the first edge terminal device may acquire the first image and perform image recognition on the first image to obtain a recognition result; and detect the game state of the first game table according to the recognition result and the updated first local configuration file.

In the embodiment of the disclosure, the first image is obtained based on a scenario image of a game scenario of the first game table that is collected by the collection device. The collection device may be implemented as a camera. The collection device configured on the first game table may be one camera, and may also be multiple cameras, which is not limited thereto by the disclosure.

In some embodiments, the collection device may be multiple cameras arranged at multiple different angles. The multiple cameras may collect multiple video frame sequences of the game scenario of the first game table. The first edge terminal may acquire multiple images from the multiple video frame sequences, and splice the multiple images to obtain a first image; or, may respectively perform image recognition based on images collected by the cameras at different angles, and fuse recognition results of respective images. Therefore, in a case where some parts of some images in the multiple images are unclear due to blocking and other reasons, and cannot be subjected to the image recognition, a clear first image may still be obtained, and the first image is used for the image recognition.

In the embodiment of the disclosure, the multiple configuration files include: a configuration file of a collection component corresponding to a collection device and a configuration file of a table component.

In some embodiments, a content that may be configured by the configuration file of the collection component includes: an enabled camera and/or a camera angle.

In some embodiments, a content that may be configured by the configuration file of the table component includes at least one of the followings: game participant information, a hot region map, a game table type or a game rule. The game participant information includes at least one of the number, identifiers, positions or types of game participants. The hot region map is a game table partition map predefined according to an event generation rule or a game state detection logic in the game, and includes position information of such regions as a token placement region and a dealing region.

In the embodiment of the disclosure, the image recognition may include at least one of the followings: biological feature recognition, a table game information recognition, or association recognition of the biological feature recognition and the table game information recognition.

In some embodiments, the biological feature recognition may include at least one of the followings: face recognition, body recognition, or association recognition of face and body.

Exemplarily, the configuration file of the table component includes the game participant information. Two types of players are configured on the first game table: a type-A player and a type-B player. After performing the face recognition on the first image, the first edge terminal device obtains a recognition result that the actual players on the first game table include the type-B player and a type-C player, and the first edge terminal may determine that the type of player does not match with the game table.

In some embodiments, the table game information recognition may include recognition on at least one of the followings: a table game tool, a table game region, a table game rule, a table game result, a table game operation and a table game process.

Exemplarily, the table game tool may include a game card, a token and the like; the table game region may include a game card placement region, a token placement region and the like; the table game rule may include a dealing sequence; the table game operation may include an operation of a game controller and an operation of a player; and the table game process may be configured to characterize different stages of the game.

Exemplarily, the configuration file of the table component includes the configuration file of the token region. The first edge terminal may perform association recognition of the biological feature recognition and the table game information on the first image to obtain an association recognition result between the player and the token; and prompt of an error in the token placement region in a case where the association recognition result characterizes that a player A places the token in the token placement region of a player B.

Exemplarily, the multiple configuration files configure a standard action for the operation of the game participant. The first edge terminal may recognize an operation action of the game participant in the first image, and prompt the game participant of the illegal operation action when determining that the operation action of the game participant is not the standard action.

It is to be understood that the first edge terminal may first acquire the description information of the multiple configuration files from the cloud; and quickly determine, according to the file version in the description information, the first configuration file that is updated on the cloud, then update the first local configuration file with the first configuration file acquired from the cloud, and detect the game state with the updated first local configuration file, thereby improving the efficiency of configuration updating and improving the accuracy of game state detection.

In some embodiments of the disclosure, the implementation that the first description information is determined from the description information of the multiple configuration files in S102 may include that: each of the description information of the multiple configuration files is compared with description information of respective one of multiple first local configuration files to determine the first description information, the multiple first local configuration files including configuration information of multiple components of the first game table.

In the embodiment of the disclosure, the multiple cloud configuration files of the cloud include configuration information of multiple components. The configuration information of the multiple components is configured to configure at least one game table corresponding to at least one edge terminal. Here, the multiple components configured for different game tables may be the same, and may also be different, which may be set according to an actual condition, and is not limited by the embodiment of the disclosure.

In the embodiment of the disclosure, the multiple configuration files include configuration information of multiple components of the first game table. The multiple first local configuration files of the first game table include the configuration information of the multiple components of the first game table. The multiple configuration files are in one-to-one correspondence with the multiple first local configuration files.

In the embodiment of the disclosure, after acquiring the description information of the multiple configuration files, the first edge terminal may compare each piece of description information in the description information of the multiple configuration files with a corresponding one piece of description information in the description information of the multiple first local configuration files, and take description information having the version higher than that of the corresponding first local configuration file in the description information of the multiple configuration files as the first description information.

In some embodiments, different file identifiers are configured to characterize different components.

Exemplarily, the file description information of the multiple configuration files is A.2, B.2 and C.1. The file description information of the first local configuration file is A.1, B.2 and C.1. The component A represents the hot region map, the component B represents the game region, and the component C represents the dealing sequence. The first edge terminal compares the versions A.1 and A.2 of the configuration file of the hot region map, the versions B.2 and B.2 of the configuration file of the game region, and the versions C.1 and C.1 of the configuration file of the dealing sequence, respectively. The file version A.2 is higher than the file version A.1, and thus the configuration of the hot region map needs to be updated. The first edge terminal may determine the A.2 as the first description information, and thus may acquire a configuration file described by the A.2 from the cloud.

It is to be understood that the configuration file of the first game table is divided into multiple first local configuration files, and each first local configuration file corresponds to configuration of one component. Therefore, in a case where configuration information of some components needs to be updated, some corresponding first local configuration files among the multiple first local configuration files may be updated, and partial updating of the configuration of the first game table is implemented, thereby improving the efficiency of configuration updating, and saving the communication cost for configuration information update.

In some embodiments of the disclosure, the implementation that the description information of the multiple configuration files of the first game table is acquired from the cloud in S101 may include S201 to S202 as shown in FIG. 3.

In S201, a first configuration update request is sent to the cloud in a case where a configuration update condition is satisfied, the first configuration update request being configured to request the description information of the multiple configuration files.

In the embodiment of the disclosure, the configuration update condition may include at least one of the followings: the first edge terminal receives an update notification message from the cloud, the update notification message being configured to characterize that the cloud configuration file is updated; the first edge terminal is started; the first edge terminal receives an online notification message; and a configuration update time point of the first edge terminal arrives.

In some embodiments of the disclosure, the cloud may send the update notification message to the first edge terminal in a case of detecting that at least one of the multiple cloud configuration files is updated. Therefore, the first edge terminal may send the first configuration update request to the first edge terminal in response to the update notification message, to request the description information of the multiple configuration files; and therefore, the first edge terminal may timely acquire the needed first configuration file and timely update the first local configuration file, thereby improving the accuracy of game state detection.

In some embodiments of the disclosure, after the first edge terminal is started, the first edge terminal may send the first configuration update request to the cloud to implement started configuration update.

In some embodiments of the disclosure, the cloud may send an online notification message to the first edge terminal after sensing that the first edge terminal is online. Therefore, the first edge terminal may send the first configuration update request to the cloud in response to the online notification message to implement online configuration updating.

In some embodiments of the disclosure, the first edge terminal may periodically send the first configuration update request to the cloud according to a preset time interval, to implement periodic configuration updating.

In the embodiment of the disclosure, the first configuration update request may carry the description information of the multiple first local configuration files. Therefore, the cloud may determine the description information of the multiple configuration files from the multiple cloud configuration files according to the description information of the multiple first local configuration files.

In S202, the description information of the multiple configuration files that is fed back by the cloud in response to the first configuration update request is received.

In the embodiment of the disclosure, after sending the first configuration update request to the cloud, the first edge terminal may receive the description information of the multiple configuration files that is fed back by the cloud in response to the first configuration update request.

It is to be understood that the first edge terminal may send the first update configuration request to the cloud in the case where the configuration update condition is satisfied, and acquire the description information of the multiple configuration files from the description information of the multiple cloud configuration files of the cloud through the first update configuration request.

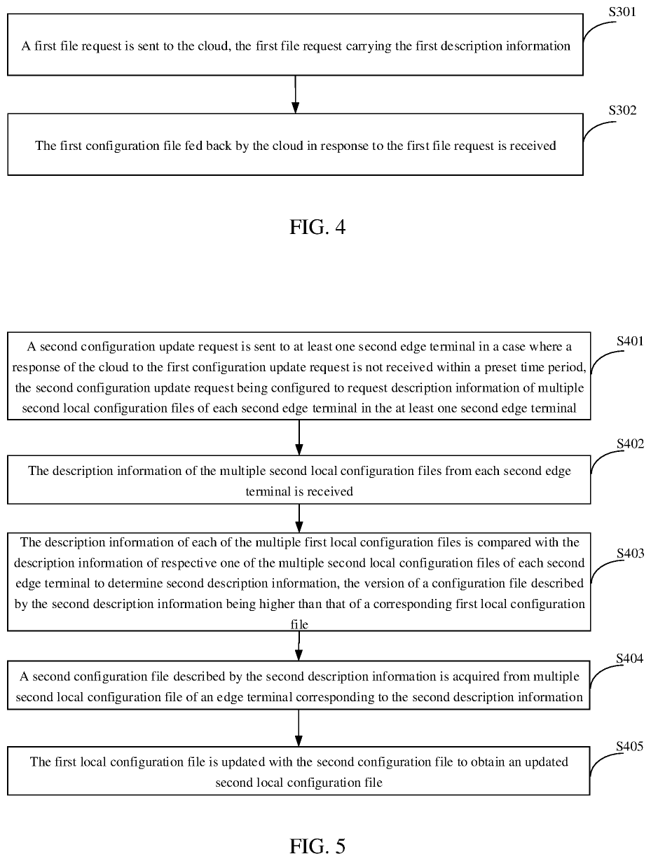

In some embodiments of the disclosure, the implementation that the first configuration file is acquired from the cloud in S103 may include the following operations as shown in FIG. 4.

In S301, a first file request is sent to the cloud, the first file request carrying the first description information.

In S302, the first configuration file fed back by the cloud in response to the first file request is received.

In the embodiment of the disclosure, the first edge terminal device may send the first file request to the cloud, the first file request carrying the first description information. Therefore, the first edge terminal may receive a response to the first file update request from the cloud; in other words, the first edge terminal may receive the first configuration file from the cloud, the first configuration file being a file described by the first description information.

It is to be understood that after determining the first description information, the first edge terminal sends the first file request to the cloud to acquire the first configuration file described by the first description information, and updates the corresponding first local configuration file through the first configuration file. Therefore, the communication cost between the first edge terminal and the cloud is reduced, and the efficiency of configuration updating is improved.

In some embodiments of the disclosure, the implementation that the first configuration file fed back by the cloud in response to the first file request is received in S302 may include that: the multiple first configuration files fed back by the cloud in response to the first file request through multiple threads are received.

In the embodiment of the disclosure, the first description information includes multiple pieces of description information. Each piece of description information corresponds to one first configuration file. The first edge terminal may receive, through multiple threads, the multiple first configuration files fed back by the cloud and corresponding to the multiple pieces of description information. Therefore, the efficiency of that the first edge terminal receives the first configuration file is improved, thereby improving the efficiency of configuration updating.

In some embodiments of the disclosure, the implementation after that the first configuration update request is sent to the cloud in the case where the configuration update condition is satisfied in S201 may include S401 to S405 as shown in FIG. 5.

In S401, a second configuration update request is sent to at least one second edge terminal in a case where a response of the cloud to the first configuration update request is not received within a preset time period, the second configuration update request being configured to request description information of multiple second local configuration files of each second edge terminal in the at least one second edge terminal.

In S402, the description information of the multiple second local configuration files from each second edge terminal is received.

In the embodiment of the disclosure, after the first edge terminal sends the first configuration update request to the cloud, if not receiving the response of the cloud to the first configuration update request within the preset time period, the first edge terminal cannot acquire the description information of the multiple configuration files from the cloud, and cannot implement the updating of the first local configuration file. By this time, the first edge terminal may further send the second configuration update request to at least one second edge terminal, to request description information of multiple second local configuration files of each second edge terminal in the at least one second edge terminal.

Here, the preset time period may be set as required, and is not limited thereto by the embodiment of the disclosure.

In the embodiment of the disclosure, after sending the second configuration update request to the at least one second edge terminal, the first edge terminal may receive the description information of the multiple second local configuration files that is fed back by each second edge terminal in the at least one second edge terminal in response to the second configuration update request. The second edge terminal may be the same as the first edge terminal in terms of type and function, and the second edge terminal and the first edge terminal may be deployed in the same environment, and/or may be managed and configured by the same cloud, and/or configured to perform information processing on a game table of the same type. For example, the first edge terminal and the second edge terminal are respectively information processing devices of two game tables of the same type in the same game scenario.

In S403, the description information of each of the multiple first local configuration files is compared with the description information of respective one of the multiple second local configuration files of each second edge terminal to determine second description information, the version of a configuration file described by the second description information being higher than that of a corresponding first local configuration file.

In the embodiment of the disclosure, after receiving the multiple second local configuration files of each second edge terminal, the first edge terminal may compare each piece of description information in the description information of the multiple first local configuration files with the description information of the corresponding second local configuration file; and determine description information having a file version higher than a corresponding first local configuration file in the description information of the multiple second local configuration files as the second description information.

In the embodiment of the disclosure, for each of the multiple first local configuration files, there may 0, 1 or more corresponding second local configuration files. The first edge terminal may determine the second description information from description information of 1 or more second local configuration files.

In some embodiments, for any one of the description information of the multiple first local configuration files, after the first edge terminal compares it with the description information of the corresponding multiple second local configuration files, and in a case of determining that file versions in the multiple pieces of description information are all higher than the file version of the first local configuration file, the first edge terminal may determine the second description information from the multiple pieces of description information.

In some embodiments, the first edge terminal may determine description information having a highest file version in the multiple pieces of description information as the second description information.

Exemplarily, the description information may include a file identifier and/or a file version. The multiple second local configuration files include A.2 from a second edge terminal 1, A.3 from the second edge terminal 2 and A.1 from a third edge terminal 3; the correspondingly, first local configuration file is A.1; and the first edge terminal may determine that description information having the file version higher than A.1 is A.2 and A.3, and takes the A.3 having the highest file version in A.2 and A.3 as the second description information.

Exemplarily, the description information includes at least one of a file identifier, a file version or an edge terminal identifier. The multiple first local configuration files include A.1, B.2 and C.1, the description information of the multiple second local configuration files of the second edge terminal 1 is A.2-1, B.2-1 and D.2-1, and the description information of the multiple second local configuration files of the second edge terminal 2 is A.2-2, C.1-2 and E.2-2, X in “−X” being the edge terminal identifier. Therefore, the second local configuration files that may be acquired by the first edge terminal are A.2-1, B.1-1, D.2-1, A.2-2, C.1-2 and E.2-2. The first edge terminal may determine that the description information higher than the first local configuration file is A.2-1 and A.2-2, and then take either A.2-1 or A.2-2 as the second description information.

In S404, a second configuration file described by the second description information is acquired from multiple second local configuration file of an edge terminal corresponding to the second description information.

In the embodiment of the disclosure, after determining the second description information, the first edge terminal may acquire the second configuration file according to the second description information. The second configuration file is a configuration file described by the second description information.

In some embodiments, the first edge terminal may send a second file request to each second edge terminal in the at least one second edge terminal, the second file request carrying the second description information. Therefore, in a case where any second edge terminal in the at least one second edge terminal finds second description information from description information of its own multiple second local configuration files, second edge terminal sends a second local configuration file described by the second description information to the second edge terminal in response to the second file request.

Exemplarily, the second description information includes A.3, the multiple second local configuration files of the second edge terminal 1 include A.2, and the multiple second local configuration files of the second edge terminal 2 include A.3. After sending the second file request carrying the A.3 to the second edge terminal 1 and the second edge terminal 2, the first edge terminal may receive A.3 fed back by the second edge terminal 2 in response to the second file request.

In some embodiments, the second description information includes an edge terminal identifier, and the first edge terminal may send the second file request to a second edge terminal corresponding to the edge terminal identifier, the second file request carrying the second description information. Therefore, the second edge terminal corresponding to the edge terminal identifier may send the second configuration file to the first edge terminal in response to the second file request.

In S405, the first local configuration file is updated with the second configuration file to obtain an updated second local configuration file.

In the embodiment of the disclosure, after acquiring the second configuration file, the first edge terminal may update the first local configuration file with the second configuration file to obtain the updated first local configuration file.

It is to be understood that in a case where the cloud cannot respond to the first configuration update request of the first edge terminal, the first edge terminal may further acquire description information of multiple second local configuration files of at least one second edge terminal, and determine second description information from the description information of the multiple second local configuration files of the at least one second edge terminal; and then acquire a second configuration file corresponding to the second description information to update the first local configuration file. That is, in a case where the first edge terminal cannot acquire the first configuration file from the cloud, for example in a case where the cloud is in fault or a connection between the first edge terminal and the cloud is in fault, the second configuration file may further be acquired from other edge terminals to update the first local configuration file. Therefore, the flexibility of configuration updating is increased, and the first edge terminal can timely update the first local configuration file.

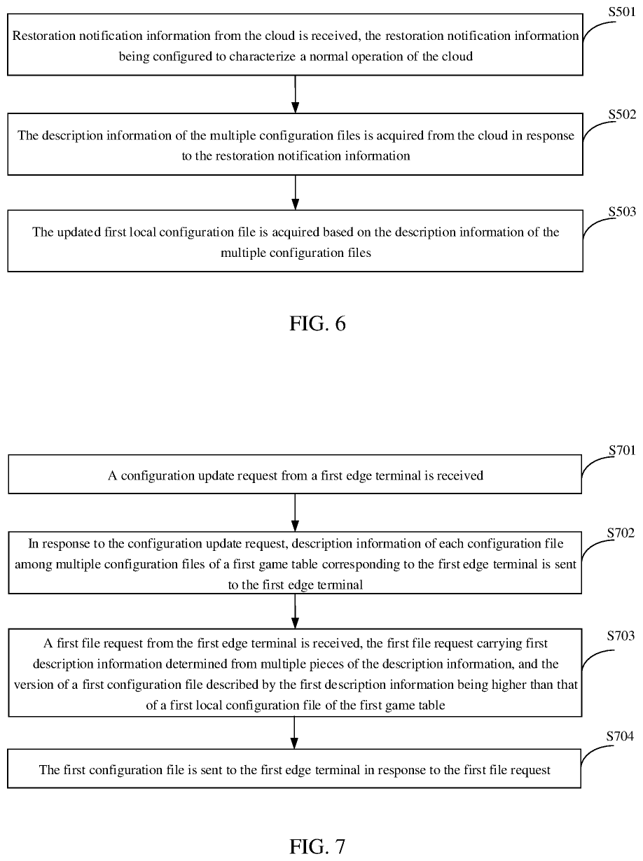

In some embodiments of the disclosure, the implementation after that the second configuration update request is sent to the at least one second edge terminal in the case where the response of the cloud to the first configuration update request is not received within the preset time period in S401 may include S501 to S503 as shown in FIG. 6.

In S501, restoration notification information from the cloud is received, the restoration notification information being configured to characterize a normal operation of the cloud.

In S502, the description information of the multiple configuration files is acquired from the cloud in response to the restoration notification information.

In the embodiment of the disclosure, upon the reception of the restoration notification information from the cloud, the first edge terminal may determine that the cloud restores the normal operation. By this time, the first edge terminal may send the first configuration update request to the cloud, and acquire the description information of the multiple configuration files from the cloud based on the first configuration update request.

In S503, the updated first local configuration file is acquired based on the description information of the multiple configuration files.

In the embodiment of the disclosure, the manner in which the first edge terminal acquires the updated first local configuration file based on the description information of the multiple configuration files after acquiring the description information of the multiple configuration files refers to the descriptions in S102-S104, and will not be repeated here.

It is to be understood that as the multiple second local configuration files of the at least one second edge terminal may not have a file corresponding to some first local configuration files, or, the file corresponding to some first local configuration files in the multiple second local configuration files of the at least one second edge terminal is also not timely updated through the cloud, the first edge terminal may continuously acquire the first configuration file through the cloud after the cloud restores the normal operation to update the first local configuration file, and thus the first local configuration file is timely updated, thereby improving the accuracy of game state detection.

In some embodiments of the disclosure, the implementation that the game state of the first game table is detected according to the updated first local configuration file, as well as the first image collected for the first game table in S105 may include that: a game process of the first game table is detected according to the updated first local configuration file, as well as the first image collected for the first game table.

In the embodiment of the disclosure, the first edge terminal device may perform image recognition on the first image to obtain a recognition result; and detect the game process of the first game table according to the recognition result and the updated first local configuration file.

Here, the game process is configured to characterize different stages of the game. For example, one game may at least include a token placement stage, a game playing stage and a game payment stage. In the token placement stage, the game participant may place the token in the token placement region; in the dealing stage, the game controller starts dealing, and the game participant cannot operate the token in the token placement region; and in the game payment stage, the game controller may operate the token in the token placement region.

Exemplarily, the first edge terminal device may perform association recognition of biological feature recognition and table information on the first image to obtain an association recognition result, and determine that the game on the first game table enters the game dealing stage after the association recognition result characterizes that a hand of the game controller operates a game card.

In some embodiments of the disclosure, the implementation that the game state of the first game table is detected according to the updated first local configuration file, as well as the first image collected for the first game table in S105 may include that: an operation of a game participant of the first game table is detected according to the updated first local configuration file, as well as the first image collected for the first game table.

In the embodiment of the disclosure, the first edge terminal device may perform image recognition on the first image to obtain a recognition result; and detect the operation of the game participant of the first game table according to the recognition result and the updated first local configuration file.

Here, the operation of the game participant includes an operation of the game controller and an operation of the player.

In some embodiments, the first edge terminal may perform biological feature recognition on the first image to recognize the operation action of the game participant, and take the operation action of the game participant as the operation of the game participant.

Exemplarily, the first edge terminal determines that the game participant has an illegal action in a case of recognizing that the operation action of the game participant is consistent with a preset illegal action (for example, changing the card secretly).

In some embodiments, the first edge terminal may perform association recognition of biological feature recognition and the table information on the first image to obtain an operation of the game participant on a game tool, and take it as the operation of the game participant.

Exemplarily, the first edge terminal recognizes that the operation of the game participant on the game tool is: the player A places a token in the game placement region B; the configuration information of the token placement region included in the updated first local configuration file is: the player A corresponds to the token placement region A; and the first edge terminal may detect the illegal operation of the player A according to the updated first local configuration file.

In some embodiments of the disclosure, the implementation that the game state of the first game table is detected according to the updated first local configuration file, as well as the first image collected for the first game table in S105 may include that: a game result of the first game table is detected according to the updated first local configuration file, as well as the first image collected for the first game table.

In the embodiment of the disclosure, the first edge terminal may perform table game information recognition on the first image to obtain a recognition result of table game information; and determine the game result according to the recognition result of the table game information.

Exemplarily, the first edge terminal recognizes the number of points of the game card from the first image, performs sorting according to the number of points of the game card, and determines the game result according to a sorting result.

FIG. 7 is an optional flowchart schematic diagram of a configuration updating method provided by an embodiment of the disclosure. The configuration updating method is applied to a cloud, and is described in combination with steps shown in FIG. 7.

In S701, a configuration update request from a first edge terminal is received.

In S702, in response to the configuration update request, description information of each configuration file among multiple configuration files of a first game table corresponding to the first edge terminal is sent to the first edge terminal.

In the embodiment of the disclosure, there are multiple cloud configuration files in the cloud, the multiple cloud configuration files including configuration files of all edge terminals; the cloud may determine the multiple configuration files of the first game table from the multiple cloud configuration files in response to the first configuration update request upon the reception of the configuration update request of the first edge terminal, and send the determined description information of each configuration file among the multiple configuration files to the first edge terminal. The multiple configuration files of the first game table correspond to the first local configuration file of the first edge terminal; and the first local configuration file of the first edge terminal includes configuration information of the first game table.

In some embodiments of the disclosure, the configuration update request carries the description information of the first local configuration file. Therefore, the cloud may determine the description information of the configuration file of the first game table from the description information of the multiple cloud configuration files according to the description information of the first local configuration file.

In some embodiments of the disclosure, the cloud may determine a cloud configuration file having the same file identifier from the multiple cloud configuration files according to the file identifier in the description information of the first local configuration file to take as the configuration file of the first game table.

In some embodiments of the disclosure, the description information of the first local configuration file includes an edge terminal identifier of the first edge terminal; and the cloud provides a correspondence between the edge terminal identifier and the cloud configuration file. Therefore, the cloud may determine a cloud configuration file corresponding to the edge terminal identifier of the first edge terminal from the multiple cloud configuration files to take as the configuration file of the first game table.

In the embodiment of the disclosure, the cloud may send the description information of the configuration file of the first game table to the first edge terminal after determining the configuration file of the first game table. Therefore, the first edge terminal may determine the first description information from the description information of the configuration file. The configuration file described by the first description information is description information of a file to be updated by the first edge terminal.

In S703, a first file request from the first edge terminal is received, the first file request carrying first description information determined from multiple pieces of the description information, and the version of a first configuration file described by the first description information being higher than that of a first local configuration file of the first game table.

In the embodiment of the disclosure, after sending the description information of the multiple configuration files to the first edge terminal, the cloud may receive the first file request sent by the first edge terminal. The first file request carries the first description information; the first description information is at least one piece of description information determined by the first edge terminal from the description information of the multiple configuration files; and the version of the first configuration file described by the first description information is higher than that of the first local configuration file of the first game table.

In S704, the first configuration file is sent to the first edge terminal in response to the first file request.

In the embodiment of the disclosure, upon the reception of the first file request, the cloud may determine the cloud configuration file described by the first description information as the first configuration file, and send the first configuration file to the first edge terminal.

It is to be understood that the cloud may determine the cloud configuration file corresponding to the first local configuration file from the multiple cloud configuration files, and send description information of these cloud configuration files to the first edge terminal; and the cloud may receive, based on the description information sent to the first edge terminal, the first description information determined by the first edge terminal and having the version higher than that of the first local configuration file. Therefore, the terminal may send the first configuration file described by the first description information to the first edge terminal; and the first edge terminal acquires the first configuration file having the version higher than that of the first local configuration file from the cloud, and updates the first local configuration file with the first configuration file. The communication cost between the first edge terminal and the cloud is reduced, and the efficiency of configuration updating of the first edge terminal is improved.

In some embodiments of the disclosure, in a case of acquiring update data of the first cloud configuration file in the multiple cloud configuration files, the cloud updates the first cloud configuration file based on the update data to obtain the updated first cloud configuration file. The file version of the updated first cloud configuration file is higher than that of the first cloud configuration file.

In the embodiment of the disclosure, in a case of acquiring update data of any file in the multiple cloud configuration files, the cloud updates the cloud configuration file and increases the file version of the cloud configuration file. Therefore, the file version of the updated cloud configuration file is higher than that of the cloud configuration file before updated.

It is to be understood that the cloud increases the file version of the cloud configuration file once whenever the cloud configuration file is updated. Therefore, the file version of the cloud configuration file may reflect an update condition of the cloud configuration file. The first edge terminal may quickly determine, according to the file version of the cloud configuration file, the local configuration file that needs to be updated.

The embodiments of the disclosure provide a configuration updating method, which may be applied to a second edge terminal, and include S801 to S804.

In S801, a configuration update request from a first edge terminal is received.

In S802, in response to the configuration update request, description information of each configuration file among multiple configuration files of a first game table corresponding to the first edge terminal is sent to the first edge terminal.

In the embodiment of the disclosure, the second edge terminal may receive the configuration update request from the first edge terminal, the configuration update request carrying description information of a first local configuration file. The configuration update request is configured to request description information for describing the configuration file of the first game table. Therefore, the second edge terminal determines the description information of the configuration file of the first game table from a local configuration file of the second edge terminal (i.e., the description information of the second local configuration file) in response to the second configuration update request to send to the first edge terminal.

In S803, a first file request from the first edge terminal is received, the first file request carrying first description information determined from multiple pieces of the description information, and the version of a first configuration file described by the first description information being higher than that of a first local configuration file of the first game table.

In the embodiment of the disclosure, after sending the description information for describing the configuration file of the first game table to the first edge terminal, the second edge terminal may receive the first file request, the first file request carrying the first description information; the first description information is at least one piece in the description information of the multiple second local configuration files; and the version of the first configuration file described by the first description information is higher than that of the first local configuration file.

Exemplarily, the description information of the first local configuration file of the first edge terminal is A.1, B.1 and C.1; the description information of the second local configuration file of the second edge terminal is A.2, B.1 and C.1; and the first edge terminal sends a configuration update request to the second edge terminal, the configuration update request carrying description information A.1, B.1 and C.1 of the first local configuration file. Therefore, upon the reception of the configuration update request, the second edge terminal may send the description information A.2 and B.1 for configuring the configuration file of the first game table in the second local configuration file to the first edge terminal; and upon the reception of the description information A.2 and B.1, the first edge terminal may respectively compare the A.2 and the B. 1 with the description information A.1 and B.1 of the first local configuration file, the version of a configuration file corresponding to the description information A.2 being higher than that of a configuration file corresponding to the description information A.1, and the first edge terminal determines the A.2 as the first description information, and carries the A.2 in the first file request to send to the second edge terminal.

In S804, the first configuration file is sent to the first edge terminal in response to the first file request.

In the embodiment of the disclosure, upon the reception of the first file request, the second edge terminal may determine a file described by the first description information from the second local configuration file as the first configuration file and send the first configuration file to the first edge terminal.

It is to be understood that in response to the configuration update request of the first edge terminal, the second edge terminal may first send the description information of the first local configuration file to the first edge terminal; and then, after determining the first description information from the description information of the first local configuration file, the first edge terminal sends the first description information to the second edge terminal. Therefore, the second edge terminal may send the first configuration file described by the first description information to the first edge terminal, such that the first edge terminal completes updating of the first local configuration file; and the flexibility of configuration update of the first edge terminal is improved.

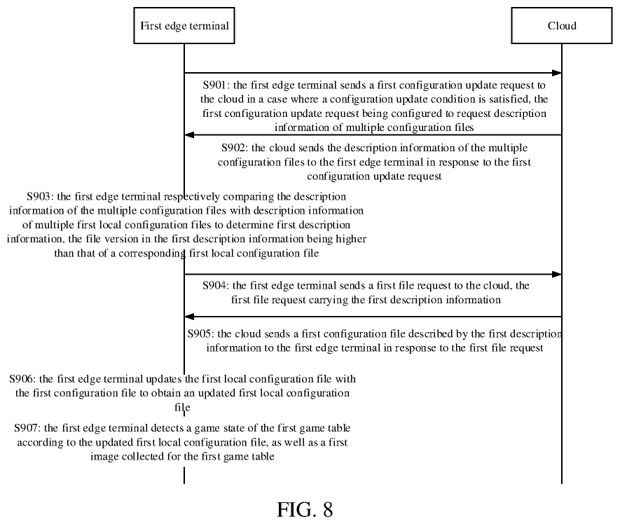

Reference is made to FIG. 8. FIG. 8 is an optional flowchart schematic diagram of a game state detection method provided by an embodiment of the disclosure. The game state detection method is applied to an interactive process between a first edge terminal and a cloud, and is described in combination with steps shown in FIG. 8.

In S901, the first edge terminal sends a first configuration update request to the cloud in a case where a configuration update condition is satisfied, the first configuration update request being configured to request description information of multiple configuration files.

In S902, the cloud sends the description information of the multiple configuration files to the first edge terminal in response to the first configuration update request.

In S903, the first edge terminal comparing the description information of each of the multiple configuration files with description information of respective one of multiple first local configuration files to determine first description information, the file version in the first description information being higher than that of a corresponding first local configuration file.

In S904, the first edge terminal sends a first file request to the cloud, the first file request carrying the first description information.

In S905, the cloud sends a first configuration file described by the first description information to the first edge terminal in response to the first file request.

In S906, the first edge terminal updates the first local configuration file with the first configuration file to obtain an updated first local configuration file.

In S907, the first edge terminal detects a game state of the first game table according to the updated first local configuration file, as well as a first image collected for the first game table.

In the embodiment of the disclosure, the first edge terminal may acquire the description information of the multiple configuration files from the cloud by sending the first configuration update request to the cloud. Therefore, the first edge terminal may determine the first description information according to the description information of the multiple configuration files, and then carry the first description information in the first file request to send to the cloud, thereby receiving the first configuration file described by the first description information from the cloud. The first local configuration file is updated with the first configuration file, such that the efficiency of configuration updating is improved; and the first edge terminal timely detects the game state of the first game table with the updated first local configuration file, thereby improving the accuracy of game state detection.

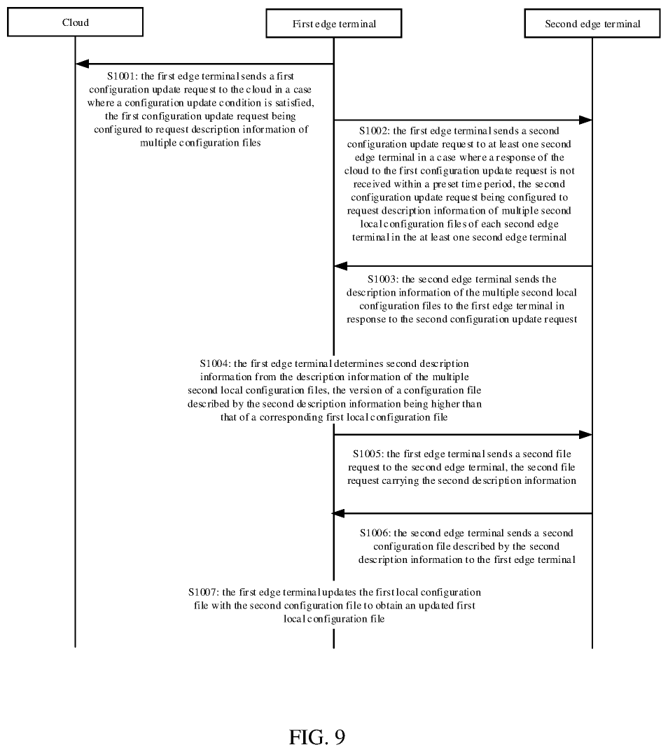

Reference is made to FIG. 9. FIG. 9 is an optional flowchart schematic diagram of a game state detection method provided by an embodiment of the disclosure. The game state detection method is applied to an interactive process among a first edge terminal, a cloud and a second edge terminal, and is described in combination with steps shown in FIG. 9.

In S1001, the first edge terminal sends a first configuration update request to the cloud in a case where a configuration update condition is satisfied, the first configuration update request being configured to request description information of multiple configuration files.

In S1002, the first edge terminal sends a second configuration update request to at least one second edge terminal in a case where a response of the cloud to the first configuration update request is not received within a preset time period, the second configuration update request being configured to request description information of multiple second local configuration files of each second edge terminal in the at least one second edge terminal.

In S1003, the second edge terminal sends the description information of the multiple second local configuration files to the first edge terminal in response to the second configuration update request.

In S1004, the first edge terminal determines second description information from the description information of the multiple second local configuration files, the version of a configuration file described by the second description information being higher than that of a corresponding first local configuration file.

In S1005, the first edge terminal sends a second file request to the second edge terminal, the second file request carrying the second description information.

In S1006, the second edge terminal sends a second configuration file described by the second description information to the first edge terminal.

In S1007, the first edge terminal updates the first local configuration file with the second configuration file to obtain an updated first local configuration file.

In the embodiment of the disclosure, in a case where the cloud cannot respond to the first configuration update request of the first edge terminal, the first edge terminal may further acquire description information of multiple second local configuration files from the second edge terminal, and determine second description information having the version higher than that of the first local configuration file from the description information of the multiple second local configuration files; and then acquire a second configuration file described by the second description information to update the first local configuration file; and the first edge terminal detects the game state of the first game table according to the updated first local configuration file, as well as the first image collected for the first game table. That is, the first edge terminal may perform the configuration updating through the second edge terminal, to increase the flexibility of configuration updating.

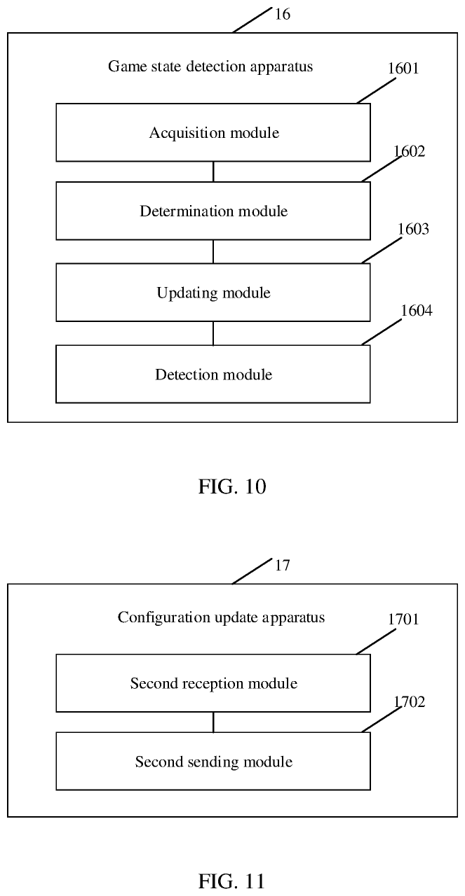

FIG. 10 is an optional structural schematic diagram of a game state detection apparatus provided by an embodiment of the disclosure. Applied to a first edge terminal, and as shown in FIG. 10, the game state detection apparatus 16 may include: an acquisition module 1601, a determination module 1602, an updating module 1603 and a detection module 1604.

The acquisition module 1601 is configured to acquire description information of multiple configuration files of a first game table from a cloud.

The determination module 1602 is configured to determine first description information from the description information of the multiple configuration files, the version of a first configuration file described by the first description information being higher than that of a corresponding first local configuration file of the first game table.

The acquisition module 1601 is further configured to acquire the first configuration file from the cloud.

The updating module 1603 is configured to update the first local configuration file with the first configuration file to obtain an updated first local configuration file.

The detection module 1604 is configured to detect a game state of the first game table according to the updated first local configuration file, as well as a first image collected for the first game table.

In some embodiments, the determination module 1602 is further configured to compare the description information of each of the multiple configuration files with description information of respective one of multiple first local configuration files to determine the first description information, the multiple first local configuration files including configuration information of multiple components of the first game table.

In some embodiments, the game state detection apparatus may further include a first reception module and a first sending module. The first sending module is configured to send a first configuration update request to the cloud in a case where a configuration update condition is satisfied, the first configuration update request being configured to request the description information of the multiple configuration files; and the first reception module is configured to receive the description information of the multiple configuration files that is fed back by the cloud in response to the first configuration update request.

In some embodiments, the first sending module is further configured to send a first file request to the cloud, the first file request carrying the first description information; and the first reception module is further configured to receive the first configuration file fed back by the cloud in response to the first file request.

In some embodiments, the first sending module is further configured to send a second configuration update request to at least one second edge terminal in a case where a response of the cloud to the first configuration update request is not received within a preset time period, the second configuration update request being configured to request description information of multiple second local configuration files of each second edge terminal in the at least one second edge terminal; the first reception module is further configured to receive the description information of the multiple second local configuration files from each second edge terminal; the first determination module 1602 is further configured to compare the description information of each of the multiple first local configuration files with the description information of respective one of the multiple second local configuration files of each second edge terminal to determine second description information, the version of a configuration file described by the second description information being higher than that of a corresponding first local configuration file; the first updating module 1603 is further configured to update the first local configuration file with the second configuration file to obtain the updated first local configuration file.

In some embodiments, the first reception module is further configured to receive the multiple first configuration files fed back by the cloud in response to the first file request through multiple threads.

In some embodiments, the first reception module is further configured to receive restoration notification information from the cloud, the restoration notification information being configured to characterize a normal operation of the cloud; the acquisition module 1601 is further configured to acquire the description information of the multiple configuration files from the cloud in response to the restoration notification information, and acquire the updated first local configuration file based on the description information of the multiple configuration files.

In some embodiments, the multiple configuration files include: a configuration file of a collection component corresponding to a collection device and a configuration file of a table component of a table game.

In some embodiments, the detection module 1604 is further configured to implement at least one of the followings: detecting a game process of the first game table according to the updated first local configuration file, as well as the first image collected for the first game table; detecting an operation of a game participant of the first game table according to the updated first local configuration file, as well as the first image collected for the first game table; or detecting a game result of the first game table according to the updated first local configuration file, as well as the first image collected for the first game table.

In some embodiments, the description information includes a version number of a file.

FIG. 11 is an optional structural schematic diagram of a configuration update apparatus provided by an embodiment of the disclosure. Applied to a cloud or a second edge terminal, and as shown in FIG. 11, the game state detection apparatus 17 may include: a second reception module 1701 and a second sending module 1702.

The second reception module 1701 is configured to receive a configuration update request from a first edge terminal.

The second sending module 1702 is configured to send, in response to the configuration update request, description information of each configuration file among multiple configuration files of a first game table corresponding to the first edge terminal to the first edge terminal.

The second reception module 1701 is further configured to receive a first file request from the first edge terminal, the first file request carrying first description information determined from multiple pieces of the description information, and the version of a first configuration file described by the first description information being higher than that of a first local configuration file of the first game table.

The second sending module 1702 is further configured to send the first configuration file to the first edge terminal in response to the first file request.

In some embodiments, the second sending module 1702 is further configured to determine, in response to the configuration update request, the multiple configuration files of the first game table corresponding to the first edge terminal from multiple cloud configuration files; and send the description information of each configuration file among the determined multiple configuration files to the first edge terminal.

It is to be noted that the configuration update apparatus in the embodiment of the disclosure may be the cloud, and may also be the second edge terminal, which is not limited by the embodiment of the disclosure.

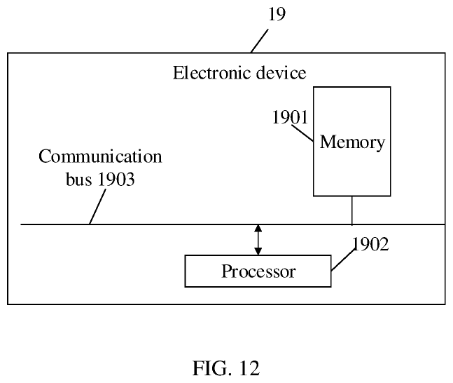

FIG. 12 is a structural schematic diagram of an electronic device according to an embodiment of the disclosure. As shown in FIG. 12, the electronic device 19 includes a memory 1901, a processor 1902 and a computer program stored on the memory 1901 and capable of running on the processor 1902. The processor is configured to run the computer program, to execute the game state detection method or the configuration updating method in the foregoing embodiments.

In some embodiments, the electronic device 19 includes a first memory, a first processor and computer program stored on the first memory and capable of running on the first processor. The first processor is configured to run the computer program, to execute the game state detection method in the foregoing embodiments.

In some embodiments, the electronic device 19 includes a second memory, a second processor and computer program stored on the second memory and capable of running on the second processor. The second processor is configured to run the computer program, to execute the configuration updating method in the foregoing embodiments.

It is to be understood that an object detection device 19 further includes a bus system 1903; and components in the communication device 19 are coupled together through the bus system 1903. It is to be understood that the bus system 1903 is configured to implement connection communication between these components. The bus system 1903 includes a data bus and further includes a power bus, a control bus and a state signal bus.

The memory 1901 is configured to store a computer program and application of the processor 1902, may further cache to-be-processed or processed data (for example, image data, audio data, voice communication data and video communication data) of each module in the processor 1902 and the object detection device, and may be implemented through a flash or a Random Access Memory (RAM).

The processor 1902 implements, when executing the program, steps of the above any game state detection method or configuration updating method. The processor 1902 typically controls an overall operation of the electronic device 19.

The processor may be at least one of an Application Specific Integrated Circuit (ASIC), a Digital Signal Processor (DSP), a Digital Signal Processing Device (DSPD), a Programmable Logic Device (PLD), a Field Programmable Gate Array (FPGA), a Central Processing Unit (CPU), a controller, a microcontroller or a microprocessor. It is to be understood that the electronic device for implementing functions of the processor may further be other devices, which is not limited by the embodiment of the disclosure.

The above computer storage medium/memory may be a memory such as a Read Only Memory (ROM), a Programmable Read-Only Memory (PROM), an Erasable Programmable Read-Only Memory (EPROM), an Electrically Erasable Programmable Read-Only Memory (EEPROM), a Ferromagnetic Random Access Memory (FRAM), a flash memory, a magnetic surface memory, an optical disc or a Compact Disc Read-Only Memory (CD-ROM); and may also be a terminal including one or any combination of the above memories, such as a server, a terminal, a mobile phone, a computer, a tablet, and a PDA.

The embodiments of the disclosure provide a computer program product or computer program. The computer program product or computer program includes a computer instruction. The computer instruction is stored in a computer-readable storage medium. A processor of a computer device reads the computer instruction from the computer-readable storage medium, and the processor executes the computer instruction, to cause the computer device to execute the above game state detection or configuration updating method in the embodiments of the disclosure.

In some embodiments, the executable instruction may use a form of a program, software, software module, script or code, may be written in any form of programming language, including compiled or interpreted languages, or declarative or procedural languages, and may be deployed in any form, including as a stand-alone program or as a module, component, subroutine, or other unit suitable for use in a computing environment.

As an example, the executable instruction may, but need not, correspond to a file in a file system, and may be stored in a portion of a file that holds other programs or data, e.g., one or more scripts stored in a Hyper Text Markup Language (HTML) document, in a single file dedicated to the program in question, or in multiple coordinated files, e.g., files that store one or more modules, sub-programs, or portions of code.

As an example, the executable instruction may be deployed to be executed on one computing device or on multiple computing devices that are located at one site or distributed across multiple sites and interconnected by a communication network.

It is to be noted that the descriptions on the above medium embodiment and device embodiment are similar to those of the above method embodiment, so the beneficial effects are the same to the method embodiment. The technical details not disclosed in the storage medium and device embodiments of the disclosure may refer to the descriptions on the method embodiment of the disclosure.

The above are merely the embodiments of the disclosure, rather than a limit to the protection scope of the disclosure. Any modifications, equivalent replacements, improvements and the like made within the spirit and scope of the disclosure shall fall within the protection scope of the disclosure.

1. A game state detection method, performed by a first edge terminal, comprising:
acquiring description information of a plurality of configuration files of a first game table from a cloud;
determining first description information from the description information of the plurality of configuration files, wherein a version of a first configuration file described by the first description information is higher than a version of a corresponding first local configuration file of the first game table;
acquiring the first configuration file from the cloud;
updating the first local configuration file with the first configuration file to obtain an updated first local configuration file; and
detecting a game state of the first game table according to the updated first local configuration file, as well as a first image collected for the first game table,
wherein determining the first description information from the description information of the plurality of configuration files comprises:
comparing a version number of each of the plurality of configuration files with a version number of a respective one of a plurality of first local configuration files to determine the first description information, wherein each configuration file and a respective first local configuration file correspond to a same component, and the plurality of configuration files correspond to a plurality of different components one by one.

2. (canceled)

3. The method of claim 1, wherein acquiring the description information of the plurality of configuration files of the first game table from the cloud comprises:
sending a first configuration update request to the cloud in a case where a configuration update condition is satisfied, wherein the first configuration update request is configured to request the description information of the plurality of configuration files; and
receiving the description information of the plurality of configuration files that is fed back by the cloud in response to the first configuration update request.

4. The method of any one of claim 1, wherein acquiring the first configuration file from the cloud comprises:
sending a first file request to the cloud, wherein the first file request carries the first description information; and
receiving the first configuration file fed back by the cloud in response to the first file request.

5. The method of claim 3, further comprising:
sending a second configuration update request to at least one second edge terminal in a case where a response of the cloud to the first configuration update request is not received within a preset time period, wherein the second configuration update request is configured to request description information of a plurality of second local configuration files of each second edge terminal in the at least one second edge terminal;
receiving the description information of the plurality of second local configuration files from the each second edge terminal;
comparing the description information of each of the plurality of first local configuration files with the description information of respective one of the plurality of second local configuration files of the each second edge terminal to determine second description information, wherein a version of a configuration file described by the second description information is higher than a version of a corresponding first local configuration file;
acquiring a second configuration file described by the second description information from a plurality of second local configuration files of an edge terminal corresponding to the second description information; and
updating the first local configuration file with the second configuration file to obtain the updated first local configuration file.

6. The method of claim 4, wherein receiving the first configuration file fed back by the cloud in response to the first file request comprises:
receiving the first configuration file fed back by the cloud in response to the first file request through a plurality of threads.

7. The method of claim 1, further comprising:
receiving restoration notification information from the cloud, wherein the restoration notification information is configured to characterize a normal operation of the cloud;
acquiring the description information of the plurality of configuration files from the cloud in response to the restoration notification information; and
acquiring the updated first local configuration file based on the description information of the plurality of configuration files.

8. The method of claim 1, wherein
the plurality of configuration files comprises: a configuration file of a collection component corresponding to a collection device, and a configuration file of a table component of a table game.

9. The method of claim 1, wherein detecting the game state of the first game table according to the updated first local configuration file, as well as the first image collected for the first game table comprises at least one of:
detecting a game process of the first game table according to the updated first local configuration file, as well as the first image collected for the first game table;
detecting an operation of a game participant of the first game table according to the updated first local configuration file, as well as the first image collected for the first game table; or
detecting a game result of the first game table according to the updated first local configuration file, as well as the first image collected for the first game table.

10. The method of claim 1, wherein the description information comprises a version number of a file.

11. A configuration updating method, performed by a cloud, comprising:
receiving a configuration update request from a first edge terminal;
sending, in response to the configuration update request, description information of each configuration file among a plurality of configuration files of a first game table corresponding to the first edge terminal to the first edge terminal;
receiving a first file request from the first edge terminal, wherein the first file request carries first description information determined from a plurality of pieces of the description information, the first description information is determined by comparing a version number of each of the plurality of configuration files with a version number of a respective one of a plurality of first local configuration files to determine the first description information, each configuration file and a respective first local configuration file correspond to a same component, the plurality of configuration files correspond to a plurality of different components one by one, and a version of a first configuration file described by the first description information is higher than a version of a first local configuration file of the first game table; and
sending the first configuration file to the first edge terminal in response to the first file request.

12. The method of claim 11, wherein sending, in response to the configuration update request, the description information of the each configuration file among the plurality of configuration files of the first game table corresponding to the first edge terminal to the first edge terminal comprises:
determining, in response to the configuration update request, the plurality of configuration files of the first game table corresponding to the first edge terminal from a plurality of cloud configuration files; and
sending description information of each configuration file among the determined plurality of configuration files to the first edge terminal.

13. An electronic device, comprising:
a memory, configured to store a computer program; and
a processor, configured to execute the computer program stored in the memory, to implement a game state detection method, the method comprising:
acquiring description information of a plurality of configuration files of a first game table from a cloud;
determining first description information from the description information of the plurality of configuration files, wherein a version of a first configuration file described by the first description information is higher than a version of a corresponding first local configuration file of the first game table;
acquiring the first configuration file from the cloud;
updating the first local configuration file with the first configuration file to obtain an updated first local configuration file; and
detecting a game state of the first game table according to the updated first local configuration file, as well as a first image collected for the first game table,
wherein determining the first description information from the description information of the plurality of configuration files comprises:
comparing a version number of each of the plurality of configuration files with a version number of a respective one of a plurality of first local configuration files to determine the first description information, wherein each configuration file and a respective first local configuration file correspond to a same component, and the plurality of configuration files correspond to a plurality of different components one by one.

14. An electronic device, comprising:
a memory, configured to store a computer program; and
a processor, configured to execute the computer program stored in the memory, to implement a configuration updating method, the method comprising:
receiving a configuration update request from a first edge terminal;
sending, in response to the configuration update request, description information of each configuration file among a plurality of configuration files of a first game table corresponding to the first edge terminal to the first edge terminal;
receiving a first file request from the first edge terminal, wherein the first file request carries first description information determined from a plurality of pieces of the description information, the first description information is determined by comparing a version number of each of the plurality of configuration files with a version number of a respective one of a plurality of first local configuration files to determine the first description information, each configuration file and a respective first local configuration file correspond to a same component, the plurality of configuration files correspond to a plurality of different components one by one, and a version of a first configuration file described by the first description information is higher than a version of a first local configuration file of the first game table; and
sending the first configuration file to the first edge terminal in response to the first file request.
